(19) United States
(12) Patent Application Publication
(10) Pub. No.: US 2016/0150746 A1
(43) Pub. Date: Jun. 2, 2016

(54) Bucket Conversion Self-Watering Planter

(71) Applicant: William J. Wood, Conway, SC (US)

(72) Inventor: William J. Wood, Conway, SC (US)

(21) Appl. No.: 15/018,483

(22) Filed: Feb. 8, 2016

Related U.S. Application Data
(63) Continuation-in-part of application No. 14/496,883, filed on Sep. 25, 2014.

(51) Int. Cl. A01G 27/02; A01G 27/06

(52) U.S. Cl. CPC A01G 27/02; A01G 27/06

(57) ABSTRACT

A one-piece drop-in device and a method of using the device to convert a bucket or other containers into a self-watering system for growing plants. The device produces a lower water reservoir and an upper area for soil, including a wicking zone wherein water from the reservoir can reach the roots of a plant via wicking or capillary action. The bucket or other container provides the bottom and side support walls to stabilize and strengthen the self-watering system.

### CROSS REFERENCE TO RELATED APPLICATIONS

This non-provisional application is a continuation-in-part of co-pending non-provisional application Ser. No. 14/496,883, filed on Sep. 25, 2014, the complete disclosure of which is expressly incorporated herein by reference in its entirety.

### BACKGROUND OF THE INVENTION

1. Field of the Invention

This invention relates to a plant container self-watering system.

1. Description of Related Art

Some self-watering systems for plants, such as houseplants, garden plants, or Christmas trees are known in the art. Examples of such systems include U.S. Pat. No. 6,497,071, Main et al. (Main) and U.S. Pat. No. 5,369,910, Copenhaver (Copenhaver) which relate to self-watering systems for Christmas trees. Other examples include U.S. Pat. No. 6,357,179, Buss (Buss), U.S. Pat. No. 6,079,156, Colovic (Colovic), and U.S. Pat. No. 5,020,261, Lishman (Lishman), which relate to self-watering planters for more general use. Known self-watering planters are expensive and may be cost-prohibitive for many home gardeners to use. Additionally, known self-watering planters are pre-manufactured from all or mostly virgin materials, and must be store bought.

### BRIEF SUMMARY OF THE INVENTION

The present invention alleviates these disadvantages of known self-watering systems in that it is simple to use, low cost, and creates an opportunity to re-use existing containers, which reduces the volume of the waste stream and conserves raw materials. The present invention is capable of converting existing buckets, pots, or other containers of varying size into self-watering planters. This reduces the cost, and is more convenient in that the home gardener can make his or her own self-watering planter primarily from materials already available. Additionally, the present invention makes it easier to move the plants from location to location.

Disclosed herein is a portable self-watering plant growing system with the water reservoir formed in the base of the container, and wherein the level of water is preferably kept uniform. Features of the disclosed embodiments include a one-piece drop-in device which creates space within the bucket or other container for a lower water reservoir (which can include other liquids, e.g., fertilizer), a lower center core of soil (or other plant-growing media) which is in communication with the liquid reservoir such that liquid from the reservoir flows, primarily by capillary or wicking action, into the soil or media, and a solid top rim that supports the weight of the upper soil. The water reservoir formed in the lower end of the container can also be used to provide plant food, fertilizer, or other liquids to the plant-growing medium or media.

Additional advantages of the disclosed system include the ability to convert inexpensive, commercially available pre-manufactured buckets, pots, or other containers into self-watering platers. Such self-watering planters include a reservoir which allows plants to thrive even when going days without refilling the water. Further, the disclosed system is green in that it encourages recycling and reuse of existing pre-manufactured buckets or other containers, and conserves water supply. The disclosed system provides a simple and economical way for people to grow fresh vegetables with minimal space or who have problematic soil. The disclosed system achieves these and other benefits with inexpensive components many of which are currently available.

### BRIEF DESCRIPTION OF THE DRAWINGS

FIG. 1 is a perspective view of one embodiment including a frustoconical lower center core wicking area.

FIG. 2 is a side view of the embodiment illustrated in FIG. 1.

FIG. 3 is a top view of the embodiment illustrated in FIG. 1.

FIG. 4 is a perspective view of another embodiment wherein the inner perimeter of the top rim and the bottom platform of the drop-in insert are star-shaped and the vertical tapering walls are linear.

FIG. 5 is a section view illustrating an embodiment of the drop-in insert and container forming a self-watering planter.

FIG. 6 is a top view of the embodiment illustrated in FIG. 4.

### DETAILED DESCRIPTION

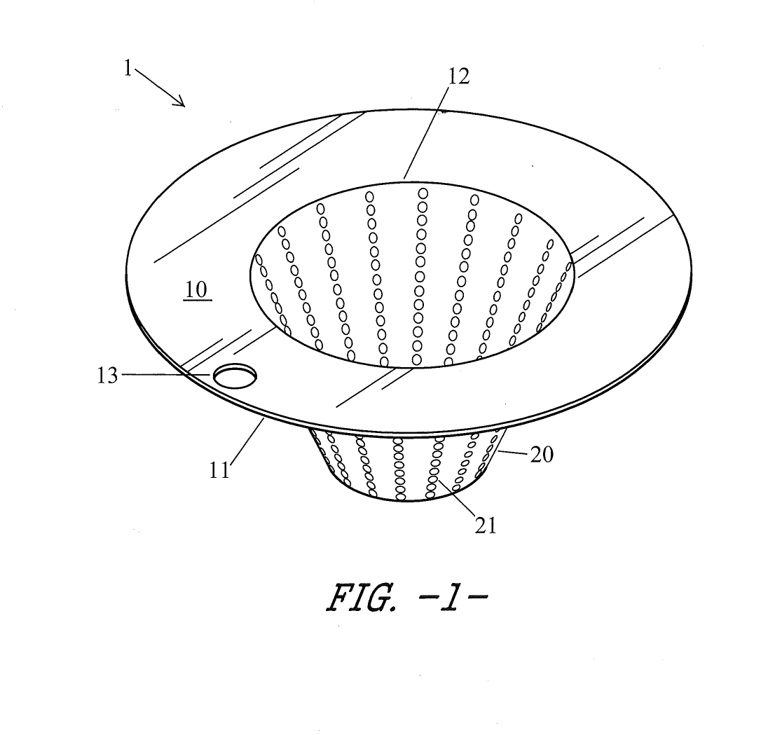

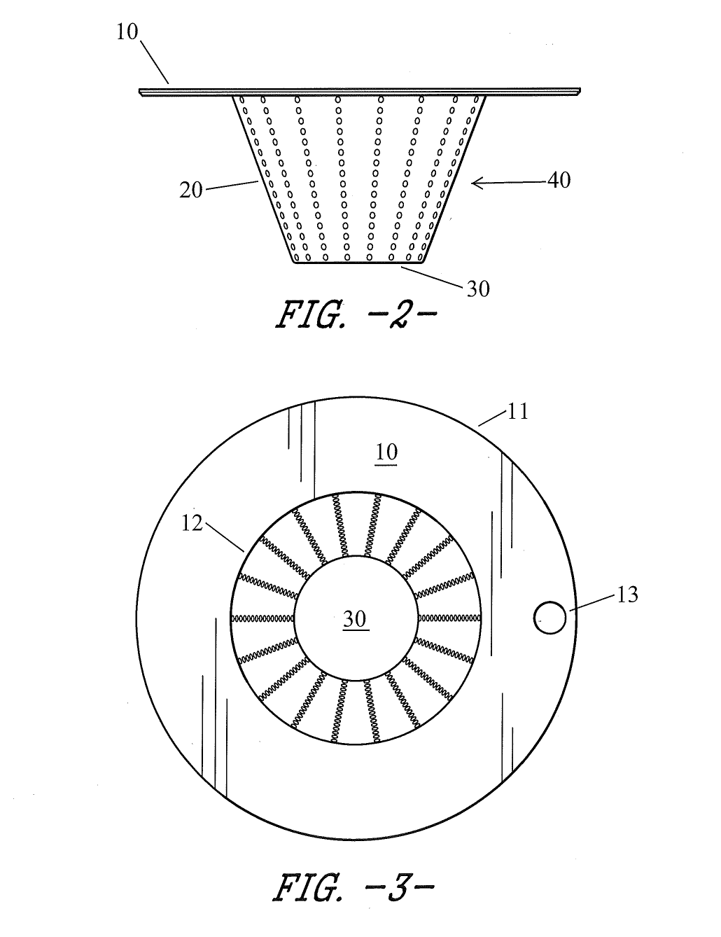

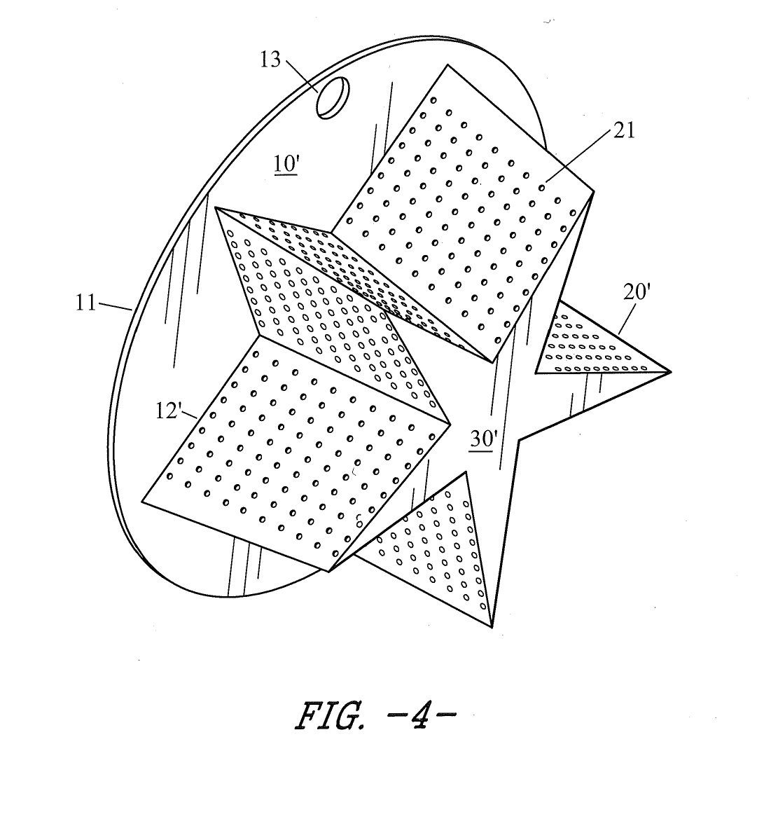

As shown in FIGS. 1-3, the drop-in device 1 can include an outer top support rim 10 which comprises a solid, non-permeable flange with an outer perimeter 11 and an inner perimeter 12. The outer perimeter and inner perimeter as illustrated in FIGS. 1-3 are circular. The outer support rim 10 also includes a hole 13 which receives a filling tube 3. Extending down from the inner perimeter 12 are one or more permeable tapering walls 20 with a plurality of holes 21 formed therein. The holes 21 are sized to permit the passage of water or other liquid while also preventing excessive amounts of soil from passing through the holes 21. In the embodiment illustrated in FIGS. 1-3, the wall 20 is a single continuous wall, defining a frustoconical shape. The one or more walls 20 terminate at a solid, non-permeable bottom platform 30 which is smaller than the inner perimeter of the outer top support rim 10. The outer top support rim 10, one or more permeable tapering walls 20, and the solid, non-permeable bottom platform 30 are integrally formed to provide a one-piece drop-in device 1 of unitary construction.

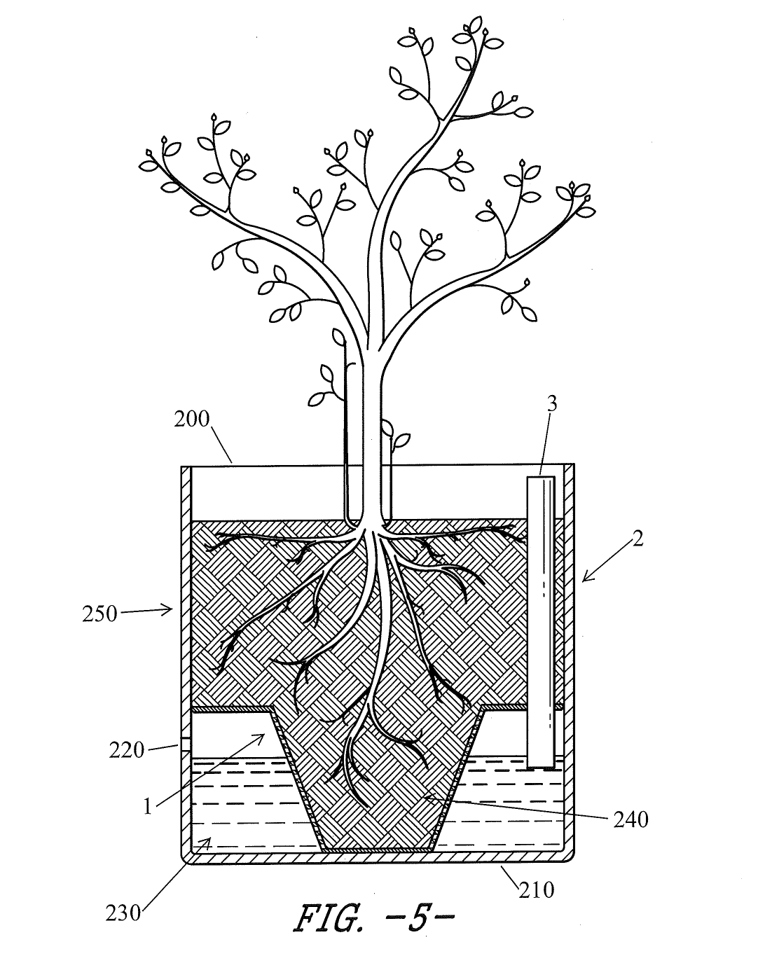

As shown in FIGS. 4 & 5, the inner perimeter 12′ of the outer top support rim 10′ and the solid, non-permeable bottom platform 30′ can also be provided in a different shape such as a star. In the embodiment illustrated in FIGS. 4 & 5, the tapering walls 20′ include ten (10) linear walls rather than the single continuous curved wall 20 illustrated in FIGS. 1-3.

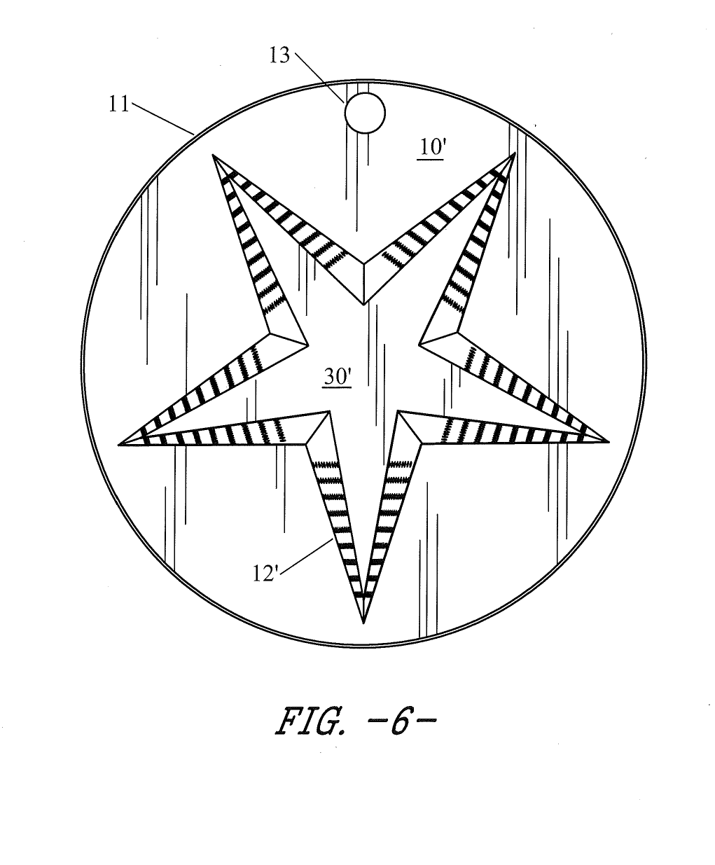

The drop-in device 1 can be used with a container 2, such as that illustrated in FIG. 5. the container includes an open top end 200 and a closed lower end 210. The drop-in device 1, when placed inside the container 2, divides the interior of container 2 into a liquid reservoir portion 230, a wicking media area 240, and a planting media support area 250. As shown in FIG. 5, the liquid reservoir portion 230 is located below the drop-in device 1. As shown in FIG. 5, the wicking media area 240 is defined by the outer top support rim inner perimeter 12, tapering permeable walls 20 and the solid, non-permeable bottom platform 30 of the drop-in device 1. As shown in FIG. 5, the planting media support area 250 is located above the outer top support rim 10 of the drop-in device 1. A drainage hole 220 is located in the side of the container 2 just below the outer top support rim 10 of the drop-in device 1 and controls the water level. The outer top support rim 10 includes a watering tube hole 13, through which a filling tube 3 of appropriate size can be used to add liquid as needed.

While preferred embodiments and example configurations have been shown and described, it is to be understood that various further modifications and additional configurations will be apparent to those skilled in the art. All such modifications and configurations are contemplated as being within the scope of the present invention. The specific embodiments and configurations disclosed are illustrative of the preferred and best modes for practicing the invention as defined by the appended claims, and should not be interpreted as limitations on the scope of the invention as defined by the appended claims. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A drop-in apparatus for converting buckets, pots, or other containers into a self-watering planter by supporting soil above a reservoir of liquid, the drop-in apparatus comprising:
a solid, non-permeable flange with an outer perimeter and an inner perimeter forming an outer top support rim for supporting soil and plant weight,
a watering tube hole in said solid, non-permeable flange for receiving a watering tube which permits introduction of liquid into the reservoir of liquid,
one or more permeable vertical tapering walls extending down from the inner perimeter of the flange,
a plurality of holes formed in said one or more permeable vertical tapering walls, said holes being sized to permit passage of water from the reservoir of liquid into the soil while also preventing excessive amounts of soil from entering the reservoir of liquid,
a solid, non-permeable bottom platform which is smaller than the inner perimeter of the solid, non-permeable flange,
said one or more permeable vertical tapering walls terminating at said solid, non-permeable bottom platform,
said solid non-permeable flange, said one or more permeable tapering vertical walls, and said solid non-permeable bottom platform being formed of a unitary, one-piece construction,
a lower center core zone bounded and defined by said solid non-permeable bottom platform, said one or more permeable vertical tapering walls, and the inner perimeter of said solid non-permeable flange,
said lower center core zone being non-prismatic and open at the upper wider end defined by the inner perimeter of said solid non-permeable flange,
said lower center core zone being closed at the smaller lower end defined by said solid non-permeable bottom platform, and
said lower center core zone permitting liquid flow in the horizontal direction while obstructing liquid flow in the vertical direction.

2. A method of converting a bucket, pot, or other container into a self-watering planter, comprising:
providing a container, said container having an open end which is nominally the upper or top end of the container and a closed end which is nominally the lower or bottom end of the container,
forming a weep hole in the side of the container,
inserting a drop-in apparatus into the container, whereby said container is divided into a liquid reservoir portion below said drop-in apparatus, and a wicking media area and a planting media support area above said drop-in apparatus,
wherein said drop-in apparatus comprises a solid, non-permeable flange with an outer perimeter and an inner perimeter forming an outer top support rim for supporting planting media and plant weight, a watering tube hole in said solid, non-permeable flange for receiving a watering tube which permits introduction of liquid into the liquid reservoir portion, one or more permeable vertical tapering walls extending down from the inner perimeter of the flange, a plurality of holes formed in said one or more permeable vertical tapering walls, said holes being sized to permit passage of water from the liquid reservoir portion into the soil while also preventing excessive amounts of soil from entering the liquid reservoir portion, a solid, non-permeable bottom platform which is smaller than the inner perimeter of the solid, non-permeable flange, said one or more permeable vertical tapering walls terminating at said solid, non-permeable bottom platform, said solid non-permeable flange, said one or more permeable tapering vertical walls, and said solid non-permeable bottom platform being formed of a unitary, one-piece construction,
wherein said wicking media area is bounded and defined by said solid non-permeable bottom platform, said one or more permeable vertical tapering walls, and the inner perimeter of said solid non-permeable flange, said wicking media area being non-prismatic and open at the upper wider end defined by the inner perimeter of said solid non-permeable flange, said wicking media area being closed at the smaller lower end defined by said solid non-permeable bottom platform, and said wicking media area permitting liquid flow in the horizontal direction while obstructing liquid flow in the vertical direction, and
inserting a watering tube through said watering tube hole in said solid, non-permeable flange of said drop-in apparatus into said liquid reservoir portion of said container.
